(19) United States
(12) Patent Application Publication
(10) Pub. No.: US 2002/0194222 A1
(43) Pub. Date: Dec. 19, 2002

(54) Method and apparatus for disabling histories in a browser

(75) Inventors: Michael Aaron Kaply, Austin, TX (US); Aaron Keith Reed, Austin, TX (US); Cristi Nesbitt Ullmann, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/884,489

(22) Filed: Jun. 18, 2001

(51) Int. Cl. G06F 17/00

(52) U.S. Cl. 707/513

(57) ABSTRACT

A method, apparatus, and computer implemented instructions for disabling collection of history information on a browser in a data processing system. A user input is received. In response to receiving the user input, history recording processes associated with the browser are disabled.

### BACKGROUND OF THE INVENTION

1. Technical Field

The present invention relates generally to an improved data processing system, and in particular to a method and apparatus for managing storage of data in a data processing system. Still more particularly, the present invention provides a method, apparatus, and computer implemented instructions for selectively disabling the recording of histories in a data processing system.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients affect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

A number of ways are present to find out what Web pages have been viewed in a browser. For example, a disk cache is present in which various files, such as graphic images, are stored with respect to a Web page. Additionally, a history list is often recorded to identify URLs that have been visited by a user. Also, a location list containing URLs entered by the user is present. Other types of disk caches include cookies for various Web sites, which are stored in a cookie file for the browser. This recorded information are examples of a history that may be recorded for a Web page received by a user or a Web site visited by the user.

In some instances, a user may desire to prevent others from identifying Web pages and Web sites that have been viewed and visited by the user. For example, a user may purchase a present for a spouse from an on-line business through a Web site. The user may wish to keep the purchase a surprise for the spouse. This surprise may be spoiled if the spouse looks at the history list recorded by the browser. Currently, the user is required to go through these various histories and delete references back to the Web page or Web site. The procedure would include, for example, deleting references in a history list, deleting files in the disk cache, and deleting cookies in a cookie file. Such a procedure is tedious and often difficult for many users. Therefore, it would be advantageous to have an improved method and apparatus for eliminating tracing of Web pages viewed by a user.

### SUMMARY OF THE INVENTION

The present invention provides a method, apparatus, and computer implemented instructions for disabling or preventing collection of history information on a browser in a data processing system. A user input is received. In response to receiving the user input, history recording processes associated with the browser are disabled.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in disabling recording of a history in accordance with a preferred embodiment of the present invention;

FIG. 4 is a block diagram of a browser program in accordance with a preferred embodiment of the present invention;

FIG. 5 is a diagram of a Web page including a mechanism for disabling recording of a history in accordance with a preferred embodiment of the present invention;

FIG. 6 is a diagram of a graphical user interface (GUI) for facilitating selective removal of history information in accordance with a preferred embodiment of the present invention;

FIG. 7 is a flowchart of a process used in a process associated with a Web page in accordance with a preferred embodiment of the present invention;

FIG. 8 is a flowchart of a process used for disabling recording of a history in a browser in accordance with a preferred embodiment of the present invention;

FIG. 9 is a flowchart of a process used to allow a user to selectively remove information from a history in accordance with a preferred embodiment of the present invention; and

FIG. 10 is a flowchart of a process used for deleting or discarding information from a history in accordance with a preferred embodiment of the present invention.

### DETAILED DESCRIPTION OF THE PREFERRED EMBODIMENT

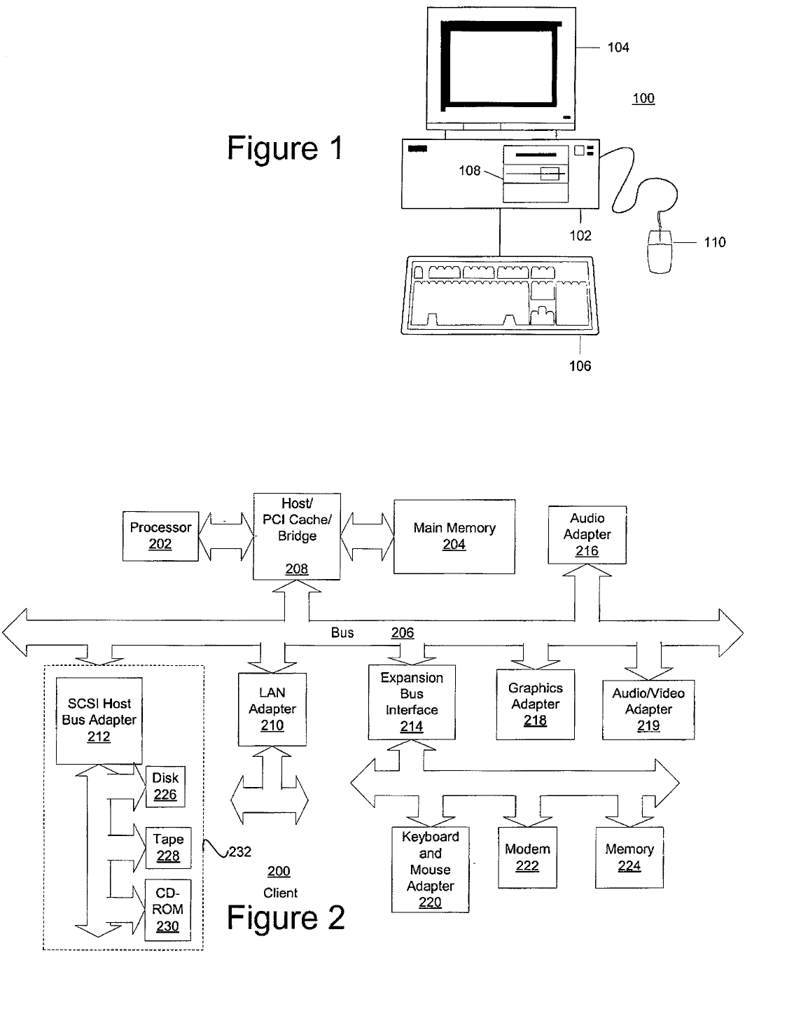

With reference now to the figures and in particular with reference to FIG. 1, a pictorial representation of a data processing system in which the present invention may be implemented is depicted in accordance with a preferred embodiment of the present invention. A computer 100 is depicted which includes a system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM RS/6000 computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows 2000, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230, as noted by dotted line 232 in FIG. 2 denoting optional inclusion. In that case, the computer, to be properly called a client computer, must include some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide nonvolatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

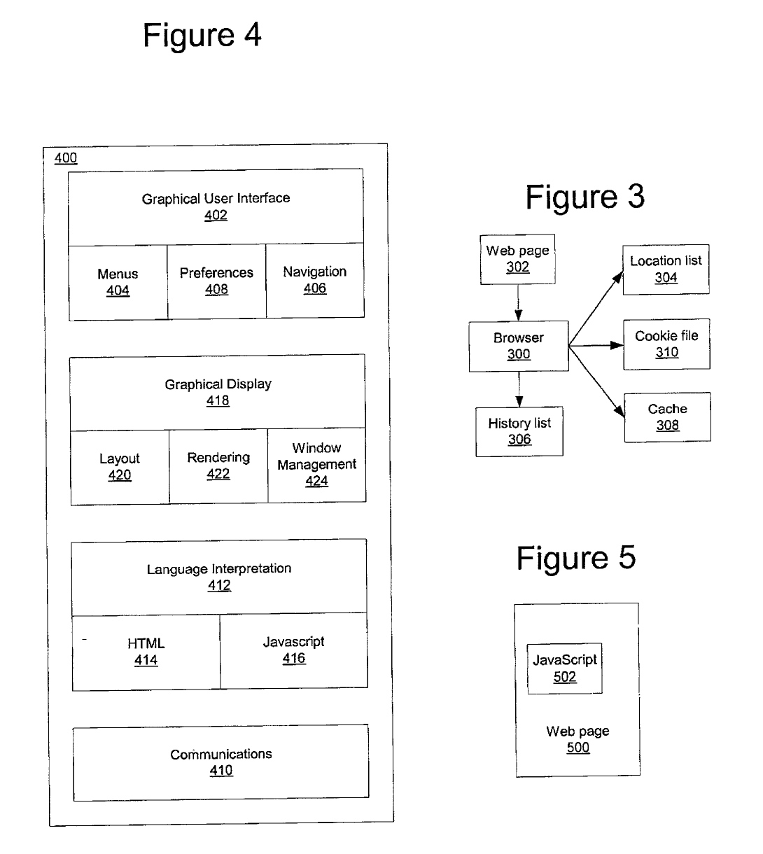

With reference now to FIG. 3, a diagram illustrating components used in disabling recording of a history is depicted in accordance with a preferred embodiment of the present invention. Browser 300 is an example of a browser, which may be executing on data processing system 200 in FIG. 2.

In this example, browser 300 receives Web page 302 for presentation. Web page 302 may be obtained by entering a URL. This URL may be stored in location list 304. Location list 304 contains URLs entered by the user. These URLs are typically entered through a field, which is often called an “address bar”. Additionally, the URL may be stored in history list 306. Further, history list 306 stores URLs to sites visited by the user by other means, such as a selection of a link. History list 306 also may contain a record of the date and time a Web page was visited by the user.

Cache 308 provides for temporary storage of Web pages received by the browser. For example, images and text for Web page 302 may be stored in cache 308. Cache 308 provides a quick way to redisplay Web page 302 if the user later returns to Web page 302. Another storage of information that may be used to trace or identify Web pages visited by a user is cookie file 310. A hidden data field, which may be included in the HTTP header of an HTML file, is a “cookie” data field. A cookie is an HTTP protocol header document element, which may be used to provide multiple data elements to the browser. Some Web sites may not function properly when the acceptance of cookies is disabled by the browser. Therefore, a user may not be able to access a Web site without having cookies accepted by the browser.

The information collected and stored by browser 300 are examples of data that form a history. The present invention provides a method, apparatus, and computer implemented instructions for disabling or preventing recording of a history. Recording of the history is disabled by disabling the storage of the Web page in cache 308, and disabling this storage of the URL in history list 306 and location list 304. Further, storage of cookies for the Web page in cookie file 310 is prevented. The normal processes used to record this type of information may be disabled in response to a disable signal. This disable signal may be generated through various mechanisms. For example, a user may select control, such as a button, displayed on browser 300. The disable signal also may be generated using selected user Ids. For example, if a temporary user logs on to a browser, the persistent storage of history information is disabled. Alternatively, the user may set a preference to disable the recording of histories. The preferences may be, for example, to disable recording at a particular time of the day, a selected day of the week, or for a particular Web site.

This mechanism prevents other users of a data processing system from identifying Web pages and Web sites visited by a user. Such a feature is useful in the situation in which the user is purchasing a surprise gift for a spouse. Additionally, this feature is especially useful with public kiosks, where a user may want to avoid having other users identify Web sites visited by the user.

Location list 304, history list 306, cache 308, and cookie file 310 are described as locations where information forming a history may be recorded. This information is also referred to as history information. These locations and the processes associated with the locations are presented for purposes of illustration and are not meant to limit the mechanism of the present invention to disabling recording of information to these particular locations. The mechanism of the present invention may be applied to disabling any process used to record information that can be used to provide a history of a visit to a particular Web page or Web site. In disabling processes used to record or keep histories, the mechanism of the present invention, in these examples, may employ the concept of a “sandbox” where a point in time is recorded where a user decides to not keep a history. At this point, the browser keeps track of all activities that occur from that point in time. When the user closes the browser or resets this option in someway, all data relating to a history is then deleted. Another concept that may be used is not keeping track of the history at all while surfing (i.e. no caching, no history). With this implementation, some information is still retained temporarily, such as cookies, which are kept because the cookies may be used to determine what happens later in a Web site.

Turning next to FIG. 4, a block diagram of a browser program is depicted in accordance with a preferred embodiment of the present invention. A browser is an application used to navigate or view information or data in a distributed database, such as the Internet or the World Wide Web. In particular, processes may be included within browser 400 to disable recording a history.

In this example, browser 400 includes a user interface 402, which is a graphical user interface (GUI) that allows the user to interface or communicate with browser 400. This interface provides for selection of various functions through menus 404 and allows for navigation through navigation 406. For example, menu 404 may allow a user to perform various functions, such as saving a file, opening a new window, displaying a history, and entering a URL. Navigation 406 allows for a user to navigate various pages and to select web sites for viewing. For example, navigation 406 may allow a user to see a previous page or a subsequent page relative to the present page. Additionally, menu 404 may allow a user to disable history recording through the selection of a button.

Preferences such as those illustrated in FIG. 4 may be set through preferences 408. The disablement of this history recording is accomplished by setting a preference in preference 408.

Communications 410 is the mechanism with which browser 400 receives documents and other resources from a network such as the Internet. Further, communications 410 is used to send or upload documents and resources onto a network. In the depicted example, communication 410 uses HTTP. Other protocols may be used depending on the implementation. Documents that are received by browser 400 are processed by language interpretation 412, which includes HTML unit 414 and JavaScript unit 416. Language interpretation 412 will process a document for presentation on graphical display 418. In particular, HTML statements are processed by HTML unit 414 for presentation while JavaScript statements are processed by JavaScript unit 416.

Graphical display 418 includes layout unit 420, rendering unit 422, and window management 424. These units are involved in presenting Web pages to a user based on results from language interpretation 412.

Browser 400 is presented as an example of a browser program in which the present invention may be embodied. Browser 400 is not meant to imply architectural limitations to the present invention. Presently available browsers may include additional functions not shown or may omit functions shown in browser 400. A browser may be any application that is used to search for and display content on a distributed data processing system. Browser 400 make be implemented using know browser applications, such Netscape Navigator or Microsoft Internet Explorer. Netscape Navigator is available from Netscape Communications Corporation while Microsoft Internet Explorer is available from Microsoft Corporation.

With reference now to FIG. 5, a diagram of a Web page including a mechanism for disabling recording of a history is depicted in accordance with a preferred embodiment of the present invention. Web page 500 is an example of a Web page, which may be received and processed by browser 400 in FIG. 4. In this example, Web page 500 includes JavaScript 502, which contains instructions for processes to disable recording a history for Web page 500. JavaScript 502 may cause a prompt to be presented to a user to enter an input indicating whether recording of a history should be disabled for Web page 500. Additionally, other traces of Web page 500 may be erased or removed through the processes in JavaScript 502. For example, traces of Web page 500 may be erased from the history list and the cache.

Alternatively, Web page 500 may be used to disable recording of a history for a subsequent Web page to be viewed by the user. A Web page turns this option on at the beginning with JavaScript. The option would be turned off when the JavaScript terminates or ends. At that point, all history information that is collected between those two points in time are deleted. In this example, the browser tracks the collection of this history information. Alternatively, a “no cache, no history” option is used in which cookies may still be retained.

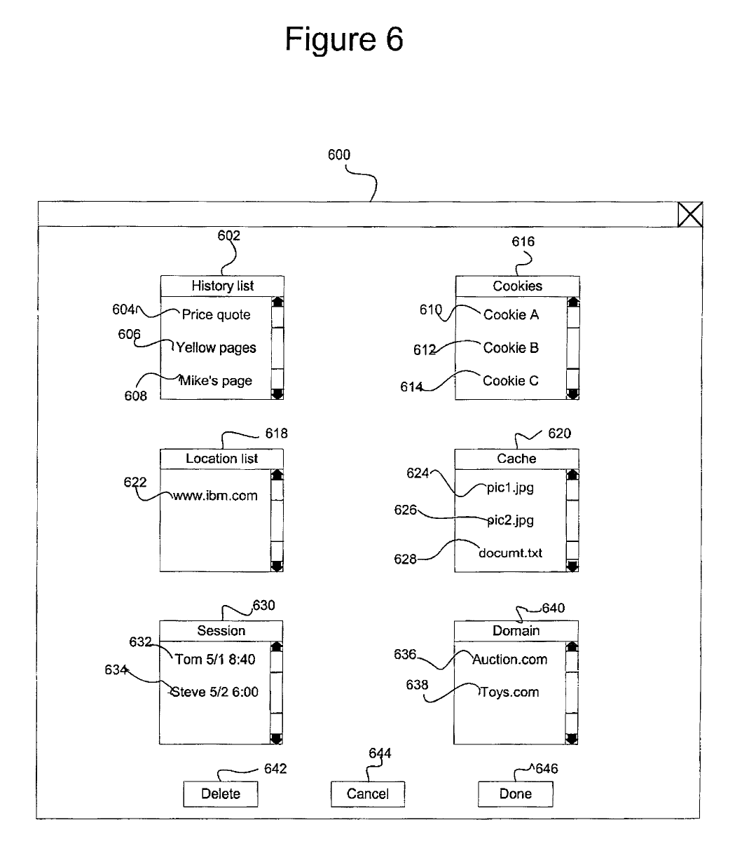

With reference now to FIG. 6, a diagram of a graphical user interface (GUI) for facilitating selective removal of history information is depicted in accordance with a preferred embodiment of the present invention. In this example, window 600 is displayed to the user when the user finishes a browser session. The browser session finishes when a user input to exit the browser is received. The information displayed in window 600 is a history for the browser session.

Field 602 displays elements 604, 606, and 608 from a history list generated during the browser session. These elements are various URLs and names associated with the URLs. Cookies 610, 612, and 614 received during the browser session are displayed in field 616. URLs entered by a user are displayed in field 618, and any names of files associated with Web pages stored in a cache are displayed in field 620. In this example, URL 622 is displayed in field 618, while files 624, 626, and 628 are displayed in field 620. Entries with fields 602, 616, 618, and 620 may be selected for deletion to delete particular pieces of information that form the history.

Field 630 contains session 632 and session 634. These are sessions that are identified based on a user Id along with a date and time of the sessions. Domain 636 and domain 638 are found in field 640. These entries identify different domains that have been visited using a browser. The domains are identified using domain names in these examples. By selecting entries in field 630 or field 640, history information relating to a particular session or domain may be selectively removed. For example, all cookies, cached files, history lists, and location lists may be deleted from a history for a particular user, while similar information for another user is retained.

The user may select various entries within these fields using a pointing device, such as a mouse, track ball, light pen, or touch pad. Selected entries may be deleted from the history by selecting “Delete” button 642. Selection of “Cancel” button 644 causes selected entries to become unselected. When the user is finished, selection of “Done” button 646 results in window 600 being removed from the display.

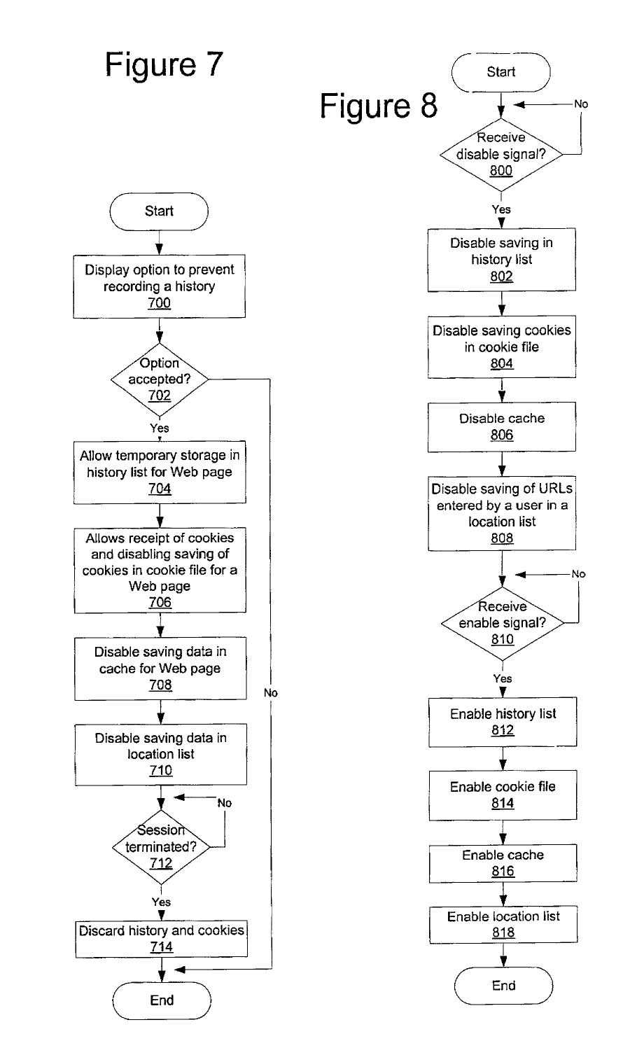

Turning next to FIG. 7, a flowchart of a process used in a process associated with a Web page is depicted in accordance with a preferred embodiment of the present invention. The process illustrated in FIG. 7 may be implemented in a JavaScript, such as JavaScript 502 in FIG. 5. In particular, this process may be used to allow a user to prevent the recording of a history for a browser session. In preventing or disabling a recording of a history, information actually received during the session is only temporarily stored with the information being erased or deleted after the session terminates.

The process begins by displaying an option to prevent recording a history (step 700). A determination is then made as to whether the option has been accepted (step 702). If the option is not accepted, the process terminates. Otherwise, a temporary storage of information in a history list for the Web page is allowed (step 704). This step tracks entries made into the history list during the session. Alternatively, universal resource locators (URLs) and other history information may be stored in a temporary data structure for use by the user during the session. In this manner, the user may view pages visited during the session, if needed. This information, however, is discarded at the end of the session, in this example. Next, receipt of cookies is allowed and the saving of cookies in a cookie file for a Web page is disabled (step 706). Then, the saving of data in a cache for the Web page is disabled (step 708). In this example, no data is saved in the cache, which requires the information to be retrieved again on subsequent visits to the Web page. Next, saving of information into a location list is disabled (step 710).

A determination is then made as to whether the session has terminated (step 712). If the session does not terminate, the process returns to step 712. When the session does terminate, the history list and any cookies received during the session are discarded (step 714) with the process terminating thereafter. If information is saved in a history list, then that information is erased from the history list. If the information is saved in a temporary data structure, the temporary data structure is discarded. Cookies may be handled in a similar fashion.

The process illustrated in FIG. 7 allows for a history of Web sites and cookies to be maintained during a browser session. This information is discarded when the session terminates, such as when the browser is closed.

With reference now to FIG. 8, a flowchart of a process used for disabling recording of a history in a browser is depicted in accordance with a preferred embodiment of the present invention. The process illustrated in FIG. 8 may be implemented in a browser, such as browser 400 in FIG. 4. In this example, the saving of information in various files used by a browser are disabled in response to a disable signal to prevent the recording of a history. The recording of a history may resume in response to receiving an enable signal.

The process begins with a determination as to whether a disable signal has been received (step 800). This disable signal may be generated using a number of different mechanisms. For example, a user may select a button displayed on the browser to indicate that the recording of a history is to be disabled. Alternatively, the signal may be generated through a preference set by the user. If a disable signal has not been received, the process continues to return to step 800 as long a disable signal has not been received.

Otherwise, the saving of information is disabled in a history list (step 802). Next, the saving of cookies in a cookie file is disabled (step 804). Saving Web pages in a cache is disabled (step 806). Further, the saving of URLs entered by a user in a location list is disabled (step 808).

Next, a determination is made as to whether an enable signal has been received (step 810). The enable signal may be initiated by the selection of a control, such as a button, by the user. Alternatively, the signal may be generated by a preference being met. For example, the preference may be to prevent the recording of a history for a particular Web site or for a selected period of time. If enable signal has not been received the process returns to step 810.

If the enable signal is received, the history list is enabled (step 812). Next, the cookie file is enabled (step 814). Then, the cache is enabled (step 816), and the location is list in enabled (step 818) with the process terminating thereafter.

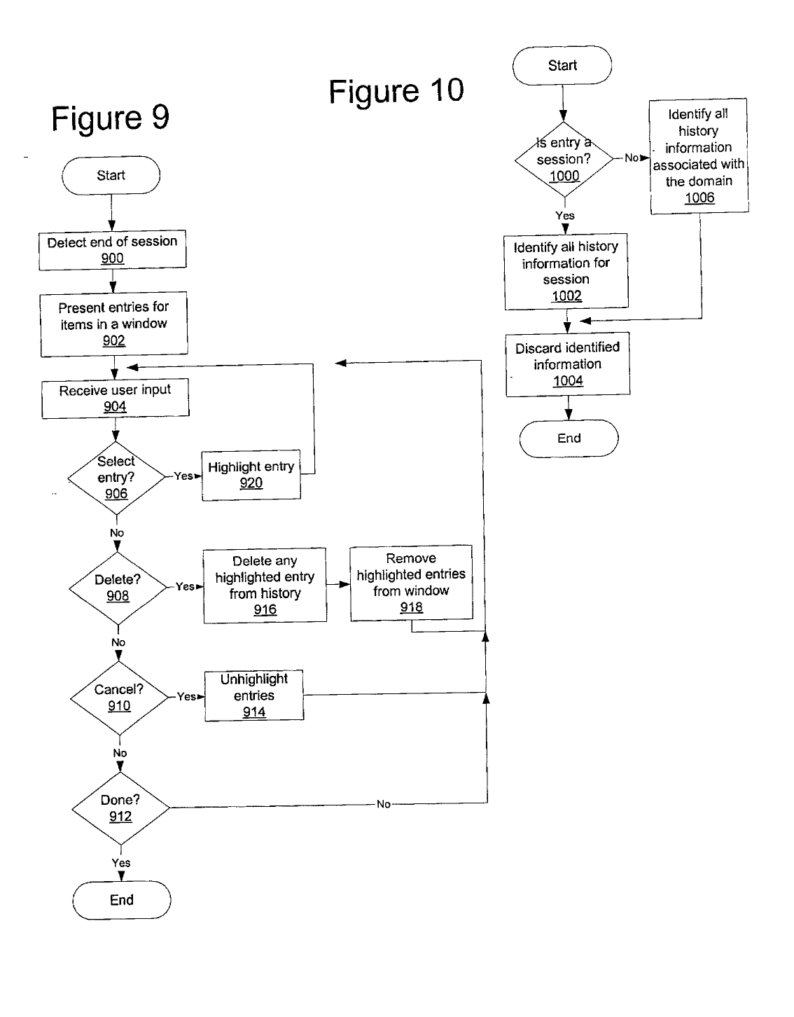

Turning next to FIG. 9, a flowchart of a process used to allow a user to selectively remove information from a history is depicted in accordance with a preferred embodiment of the present invention. The process illustrated in FIG. 9 may be implemented in a browser, such as browser 400 in FIG. 4. In particular, the processes illustrated in FIG. 9 process user input to a GUI, such as window 600 in FIG. 6.

The process begins by detecting the end of a session (step 900). In this example, the session is a browser session. Next, entries for history items are presented in a window, such as window 600 in FIG. 6 (step 902). These history items may be, for example, entries for a history list, entries for a location list, a list of cookies, a list of files in a cache, a list of prior sessions, or a list of domains visited by a user. User input is received (step 904). The user input may be, for example, a selection of an entry within the window, a selection of a control, such as a button, or a movement of the pointer.

Thereafter, a determination is then made as to whether an item is selected by the user input (step 906). If the user input is not a selection of an item, a determination is made as to whether the user input is a selection of a delete button (step 908). If the user input is not a selection of the delete button, a determination is made as to whether the user input is a selection of a cancel button (step 910). If the user input is not a selection of the cancel button, a determination is made as to whether the user input is a selection of a done button (step 912). If the user input is the selection of the done button, the process terminates. Otherwise, the process returns to step 904 as described above.

With reference again to step 910, if the user input is a selection of the cancel button, any highlighted entries are unhighlighted (step 914) with the process then returning to step 904. Turning back to step 908, if the user input is a selection of the delete button, any highlighted entries are deleted from the history (step 916). The highlighted entries are then removed from the window (step 918) and the process returns to step 904 as described above. With reference again to step 906, if the user input is a selection of an entry, the entry is highlighted (step 920) with the process returning to step 904 as described above.

With reference now to FIG. 10, a flowchart of a process used for deleting or discarding information from a history is depicted in accordance with a preferred embodiment of the present invention. The process illustrated in FIG. 10 may be implemented in as more detailed description of step 916 in FIG. 9. In particular, this process is used to handle the selection of an entry, representing a session or a domain, in a window, such as window 600 in FIG. 6.

The process begins with a determination as to whether the entry is a session (step 1000). If the entry is a session, all history information is identified for the session (step 1002). The identified information is discarded (step 1004) with process terminating thereafter. Turning back to step 1000, if the entry is not a session, all history information associated with the domain is identified (step 1006) and the process proceeds to step 1004 as described above.

Thus, the present invention provides an improved method, apparatus, and computer implemented instructions for preventing tracing of Web pages or Web sites visited by a user. This advantage is provided by disabling various mechanisms used to record information to form a history for a Web page or Web site visited by the user. This mechanism allows for increased anonymity and privacy to users. This feature is useful for users who wish to purchase items on-line or view personal information without allowing others to later view this information through a recorded history.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for disabling collection of history information on a browser, the method comprising:
receiving a user input; and
responsive to receiving the user input, disabling history recording processes associated with the browser.

2. The method of claim 1, wherein the user input is one of a selection of a button, a selection of a menu option, or setting of a preference.

3. The method of claim 2, wherein the preference is to disable the history recording processes when the browser is started.

4. The method of claim 2, wherein the preference is to disable the history recording processes when a selected Web site is visited.

5. The method of claim 1, wherein the history recording processes includes at least one of a disk cache process, a history list process, and a cookie storage process.

6. The method of claim 1, wherein the history recording process is disabled for a single session.

7. The method of claim 1, wherein the user input is the entry of a selected user identification.

8. The method of claim 7, wherein the selected user identification is a temporary user identification.

9. The method of claim 1, wherein the history recording processes are those for a particular domain.

10. The method of claim 1, wherein the disabling step includes removing any history information recorded by the browser.

11. A method in a data processing system for disabling collection of history information in a browser, the method comprising:
responsive to receiving a particular Web page, displaying an option to prevent recording a history; and
responsive to a user input selecting the option, disabling processes used to record the history.

12. The method of claim 11, wherein the history includes at least one of a disk cache, a history list, and a cookie file.

13. The method of claim 11, wherein the displaying step is performed using a script.

14. The method of claim 13, wherein the script is a JavaScript embedded in the Web page.

15. The method of claim 11 further comprising:
responsive to a user input selecting the option, removing any history information associated with the Web page.

16. A method in a data processing system for selectively preventing collection of history information on a browser, the method comprising:
responsive to a selected event, displaying an identification of sessions; and
responsive to receiving a user input selecting a session from the identification of sessions, discarding history information for the session.

17. The method of claim 16, wherein the selected event is a termination of a browser session.

18. A method in a data processing system for selectively preventing collection of history information on a browser, the method comprising:
responsive to a selected event, displaying an identification of domains in which a history information has been collected; and
responsive to receiving a user inputted selecting a domain from the identification of domains, discarding history information for the domain.

19. The method of 18, wherein the selected event is a termination of a browser session.

20. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a user input; disable history recording processes associated with the browser in response to receiving the user input.

21. A data processing system comprising:
a bus system;
a communications unit connected to the bus system;
a memory connected to the bus system, wherein the memory includes a set of instructions; and
a processing unit connected to the bus system, wherein the processing unit executes the set of instructions to display an option to prevent recording a history in response to receiving a particular Web page; and disable processes used to record the history in response to a user input selecting the option.

22. A data processing system comprising:
a bus system;
a communications unit connected to the bus system;
a memory connected to the bus system, wherein the memory includes a set of instructions; and
a processing unit connected to the bus system, wherein the processing unit executes the set of instructions to display an identification of sessions in response to a selected event; and discard history information for the session in response to receiving a user input selecting a session from the identification of sessions.

23. A data processing system comprising:
a bus system;
a communications unit connected to the bus system;
a memory connected to the bus system, wherein the memory includes a set of instructions; and
a processing unit connected to the bus system, wherein the processing unit executes the set of instructions to display an identification of domains in which a history information has been collected in response to a selected event; and discard history information for the domain in response to receiving a user input selecting a domain from the identification of domains.

24. A data processing system for disabling collection of history information on a browser, the data processing system comprising:
receiving means for receiving a user input; and
disabling means, responsive to receiving the user input, for disabling history recording processes associated with the browser.

25. The data processing system of claim 24, wherein the user input is one of a selection of a button, a selection of a menu option, or setting of a preference.

26. The data processing system of claim 25, wherein the preference is to disable the history recording processes when the browser is started.

27. The data processing system of claim 25, wherein the preference is to disable the history recording processes when a selected Web site is visited.

28. The data processing system of claim 24, wherein the history recording processes includes at least one of a disk cache process, a history list process, and a cookie storage process.

29. The data processing system of claim 24, wherein the history recording process is disabled for a single session.

30. The data processing system of claim 24, wherein the user input is the entry of a selected user identification.

31. The data procession system of claim 30, wherein the selected user identification is a temporary user identification.

32. The data processing system of claim 24, wherein the history recording processes are those for a particular domain.

33. The data processing system of claim 24, wherein the disabling step includes removing any history information recorded by the browser.

34. A data processing system for disabling collection of history information in a browser, the data processing system comprising:
displaying means, responsive to receiving a particular Web page, for displaying an option to prevent recording a history; and
disabling means, responsive to a user input selecting the option, for disabling processes used to record the history.

35. The data processing system of claim 34, wherein the history includes at least one of a disk cache, a history list, and a cookie file.

36. The data processing system of claim 34, wherein the displaying means is performed using a script.

37. The data processing system of claim 36, wherein the script is a JavaScript embedded in the Web page.

38. The data processing system of claim 34 further comprising:
removing means, responsive to a user input selecting the option, for removing any history information associated with the Web page.

39. A data processing system for selectively preventing collection of history information on a browser, the data processing system comprising:
displaying means, responsive to a selected event, for displaying an identification of sessions; and
discarding means, responsive to receiving a user input selecting a session from the identification of sessions, for discarding history information for the session.

40. The data processing system of claim 39, wherein the selected event is a termination of a browser session.

41. A data processing system for selectively preventing collection of history information on a browser, the data processing system comprising:
displaying means, responsive to a selected event, for displaying an identification of domains in which a history information has been collected; and
discarding means, responsive to receiving a user input selecting a domain from the identification of domains, for discarding history information for the domain.

42. The data processing system of 41, wherein the selected event is a termination of a browser session.

43. A computer program product in a computer readable medium for disabling collection of history information on a browser, the computer program product comprising:
first instructions for receiving a user input; and
second instructions, responsive to receiving the user input, for disabling history recording processes associated with the browser.

44. A computer program product in a computer readable medium for disabling collection of history information in a browser, the computer program product comprising:
first instructions, responsive to receiving a particular Web page, for displaying an option to prevent recording a history; and
second instructions, responsive to a user input selecting the option, for disabling processes used to record the history.

45. A computer program product in a computer readable medium for selectively preventing collection of history information on a browser, the computer program product comprising:
first instructions, responsive to a selected event, for displaying an identification of sessions; and
second instructions, responsive to receiving a user inputer selecting a session from the identification of sessions, for discarding history information for the session.

46. A computer program product in a computer readable medium for selectively preventing collection of history information on a browser, the computer program product comprising:
first instructions, responsive to a selected event, for displaying an identification of domains in which a history information has been collected; and
second instructions, responsive to receiving a user input selecting a domain from the identification of domains, for discarding history information for the domain.
